(19) United States
(12) Patent Application Publication
(10) Pub. No.: US 2024/0246144 A1
(43) Pub. Date: Jul. 25, 2024

(54) INSULATED COVERED SOFT MAGNETIC POWDER

(71) Applicant: SHOEI CHEMICAL INC., Tokyo (JP)

(72) Inventors: Masashi UMEDA, Tosu-shi (JP); Naoki ARIMITSU, Tosu-shi (JP); Michiko USUI, Tosu-shi (JP); Yuji SATO, Tosu-shi (JP); Hayato TATENO, Tosu-shi (JP)

(21) Appl. No.: 18/563,792

(22) PCT Filed: May 20, 2022
(86) PCT No.: PCT/JP2022/020988

§ 371 Date: Nov. 22, 2023

(30) Foreign Application Priority Data
May 28, 2021 (JP) 2021-90673

(51) Int. Cl. B22F 1/16; B22F 1/05; H01F 1/20

(52) U.S. Cl. CPC B22F 1/16; B22F 1/05; H01F 1/20; B22F 2301/35; B22F 2302/25; B22F 2302/256; B22F 2302/45; B22F 2304/058; B22F 2304/10

(57) ABSTRACT

An insulated covered soft magnetic powder in accordance with embodiments of the present invention comprises a soft magnetic powder having an iron content of 99.0 wt. % or more wherein at least part of the surface of the soft magnetic powder is covered with an insulating covering oxide. The insulated covered soft magnetic powder has a 50% volume cumulative particle diameter (D₅₀) by laser diffraction/scattering particle size distribution measurement of 0.01 μm to 2.0 μm, an oxygen content of 0.1 wt. % to 2.0 wt. %, a carbon content and a nitrogen content of the entire insulated covered soft magnetic powder of 0 wt. % to 0.2 wt. %, and 0 wt. % to 0.2 wt. %, respectively. The total content of oxygen, carbon and nitrogen of the insulated covered soft magnetic powder is 0.1 wt. % to 2.0 wt. % of the entire insulated covered soft magnetic powder.

### TECHNICAL FIELD

The present invention relates to an insulated covered soft magnetic powder.

This application claims priority on Japanese Patent Application No. 2021-090673 filed on May 28, 2021, the entire content of which is incorporated by reference.

### BACKGROUND ART

Transformers, choke coils, and inductors have been used as magnetic parts for power sources in the field of electronic components in recent years. Such a magnetic part has a structure having a magnetic core and a coil that is electrically conductive, placed around or inside the magnetic core. The magnetic core, which is a magnetic part for inductors etc., can be obtained as a powder magnetic core by compression molding of a soft magnetic powder. It is necessary to increase the proportion of a magnetic component in the powder magnetic core because the powder magnetic core improves magnetic properties. For increasing the proportion of a magnetic component in the powder magnetic core, a method of producing a powder magnetic core by mixing a plurality of soft magnetic powders having different particle diameters has been employed in recent years. For example, PTL 1 discloses a coil electronic part including magnetic particles having three or more particle size distributions, and a production method thereof.

In particular, a soft magnetic powder having a particle diameter of several micrometers or less is conventionally used as a substitution for a part filled with an insulator in the powder magnetic core. In this case, increasing the filling rate of the soft magnetic powder seeking higher magnetic component in the powder magnetic core leads to increased contact points of particles of the soft magnetic powder with each other. However, the contact of particles of the soft magnetic powder with each other leads to a large loss caused by currents flowing among the contacting particles (interparticle eddy currents) when a voltage is applied to a magnetic part, and the core loss of the powder magnetic core becomes large, which is problematic.

Thus, a method of reducing the core loss by covering the surface of particles of the soft magnetic powder with an insulating material to interpose an insulating covering layer between each of the particles thereby cutting between the particles the interparticle eddy currents, which are generated in the powder magnetic core, is employed. Conventionally, various insulating materials and covering methods thereof have been proposed. For example, PTL 2 discloses a soft magnetic powder that is surface-covered with an inorganic insulating layer and a resin particle layer by: forming on the surface of a soft magnetic powder that is prepared in advance, using a powder coating process such as mechano-fusion, a wet process such as electroless plating and a sol-gel method, or a dry process such as sputtering, the inorganic insulating layer made from a low melting point glass; and thereafter, further mixing the soft magnetic powder, where the inorganic insulating layer is formed, and resin particles.

### CITATION LIST

### Patent Literature

[PTL 1] Japanese Patent Application Publication No. 2016-208002
[PTL 2] WO 2005/015581
[PTL 3] WO 2018/092664

### SUMMARY OF INVENTION

### Technical Problem

As described above, an insulated covered soft magnetic powder having a small particle diameter is desired for a soft magnetic powder forming the powder magnetic core. Further, magnetic parts that can be used under a large current have been in high demand in recent years. A higher saturation magnetic flux density of a soft magnetic powder is more preferable for magnetic parts suitable for a large current. Thus, a high saturation magnetic flux density of a soft magnetic powder itself is also focused on as characteristics of an insulated covered soft magnetic powder having a small particle diameter. The saturation magnetic flux density of an iron powder is higher than that of an alloy powder based on iron, which is conventionally used as a soft magnetic powder, such as Fe—Si based alloys and Fe—Ni alloys. Furthermore, the iron powder is preferably formed of high-purity iron. Therefore, an insulated covered powder having a small particle diameter and a high saturation magnetic flux density, in particular, an insulated covered high-purity iron powder having a small particle diameter has been demanded in recent years. However, it is more difficult to produce an insulated covered high-purity iron powder having a small particle diameter than to produce an insulated covered alloy powder based on iron which has a small particle diameter.

An example of the method of producing an insulated covered soft magnetic powder is a method of producing in advance an iron powder that is a soft magnetic powder, and subjecting insulation covering to the surface of this soft magnetic powder.

An example of the method of producing an iron powder that is a soft magnetic powder is the atomization process. The atomization process is a method of obtaining particles by atomizing a melt that is set at a temperature of a melting point or higher with a high-pressure inert gas or water. However, it is difficult to atomize droplets because the viscosity of the melt is so high that ultrafine particles having a particle diameter of several micrometers or less cannot be recovered at a high yield. In addition, although water atomization is more effective than gas atomization, when an iron powder highly reactive with oxygen is produced, the inside and/or the surface of the obtained iron powder are oxidized because the iron powder also easily reacts with oxygen derived from water. Thus, the iron purity of the obtained soft magnetic powder becomes low, which causes the decline in magnetic properties of the soft magnetic powder.

An example of another method of producing an iron powder that is a soft magnetic powder is the carbonyl process. In the carbonyl process, iron pentacarbonyl is used for a raw material, and the processing temperature is not high when an iron powder is produced. Therefore, carbon and nitrogen are easily contained. Carbon and nitrogen contained in the iron powder and iron are incorporated in solid solution to form a nonmagnetic substance, which causes the decline in magnetic properties of the obtained soft magnetic powder.

As described, obtaining a high-purity iron powder as a soft magnetic powder by a conventional method is, in itself, difficult. Even when a high-purity iron powder is obtained, metal oxide layer is inevitably formed on the surface since a high-purity iron powder is highly reactive with oxygen. The metal oxide layer formed on the surface of the iron powder has low insulating properties, and moreover, transmits oxygen. Thus, for example, oxygen in the air easily diffuses into the inside via the surface of the iron powder, which causes the decline in magnetic properties of a soft magnetic powder that is an iron powder. Therefore, the oxidized surface of an iron powder obtained in the foregoing manner is conventionally subjected to further covering with an insulating material as described above so as to improve insulating properties and surface stability against oxidation. However, the step of producing a soft magnetic powder, and the step of subjecting insulation covering to the surface of an iron powder are separate in this method, and thus, the iron powder having a small particle diameter easily oxidizes between the recovery of the powder and the formation of the insulation covering. Thus, the stability of the quality of the powder obtained in this way is poor, and the steps are accompanied with the risk of heat generation and ignition due to the heat generated by the oxidation. To solve such trouble, it is necessary to treat an iron powder in an inert atmosphere to prevent the powder from oxidating, which costs enormously.

In contrast, examples of the method of carrying out simultaneously the step of producing a soft magnetic powder, and the step of subjecting the soft magnetic powder to insulation covering include the spray pyrolysis process. PTL 3 discloses a method of, using the spray pyrolysis process, producing simultaneously a soft magnetic powder and forming an insulation coating on the surface of the soft magnetic powder so as to form a glassy thin film on the surface of the soft magnetic powder. Compared to the production method including the separate steps of producing a soft magnetic powder, and subjecting the insulation covering, this method enables an insulation coating to be formed on the surface of a soft magnetic powder while limiting the oxidation of the soft magnetic powder since the production of soft magnetic powder and formation of a glassy thin film on the surface of the soft magnetic powder can be carried out in one step at once. However, when an insulated covered soft magnetic powder using a high-purity iron powder as a soft magnetic powder is produced by the spray pyrolysis process, which uses a raw material in the form of a solution, the iron powder easily reacts with oxygen derived from the stock solution, and then, the inside and/or the surface of the powder are oxidized as is the case in the atomization process. Thus the iron purity of the obtained soft magnetic powder becomes low, which causes the decline in magnetic properties of the soft magnetic powder, and moreover, of the insulated covered soft magnetic powder.

As described, there is the demand for an insulated covered soft magnetic powder that is an insulated covered high-purity iron powder, as an insulated covered soft magnetic powder having a small particle diameter. However, in production by a conventional method, oxygen, carbon, or nitrogen tends to be taken into an iron powder that is a soft magnetic powder, which decreases the iron purity of the soft magnetic powder, and the magnetic properties of the finally obtained insulated covered soft magnetic powder decline.

With the foregoing problems in view, it is an object of the present invention to provide an insulated covered soft magnetic powder such that a high-purity iron powder having a small particle diameter is used as a soft magnetic powder, and at least part of the surface of this soft magnetic powder is covered with an insulating covering oxide.

### Solution to Problem

An insulated covered soft magnetic powder according to the present invention is an insulated covered soft magnetic powder in which

An insulated covered soft magnetic powder wherein, the insulated covered soft magnetic powder comprises a soft magnetic powder having an iron content of 99.0 wt. % or more, at least part of the surface of the soft magnetic powder is covered with an insulating covering oxide,
the insulated covered soft magnetic powder has a 50% volume cumulative particle diameter (D₅₀) of 0.01 μm to 2.0 μm, as measured by laser diffraction/scattering particle size
oxygen, carbon and nitrogen contents of an entirety of the insulated covered soft magnetic powder is
0.1 wt. % to 2.0 wt. % of oxygen,
0 wt. % to 0.2 wt. % of carbon,
and 0 wt. % to 0.2 wt. % of nitrogen,
and further, a total content of oxygen, carbon and nitrogen of the entirety of the insulated covered soft magnetic powder is 0.1 wt. % to 2.0 wt. %.

### Advantageous Effects of Invention

According to the present invention, an insulated covered soft magnetic powder such that a high-purity iron powder having a small particle diameter is used as a soft magnetic powder, and at least part of the surface of this soft magnetic powder is covered with an insulating covering oxide can be provided.

### DESCRIPTION OF EMBODIMENTS

An insulated covered soft magnetic powder according to the present invention is the insulated covered soft magnetic powder such that at least part of the surface of a soft magnetic powder is covered with an insulating covering oxide. An insulated covered soft magnetic powder obtained according to the present invention has a small particle diameter, and has a high saturation magnetic flux density because of low contents of oxide, carbon and nitrogen, and further, has high insulating properties as an insulated covered soft magnetic powder.

In the insulated covered soft magnetic powder according to the present invention, the soft magnetic powder has an iron content of 99.0 wt. % or more, preferably 99.2 wt. % or more.

The iron content of the soft magnetic powder can be quantified by inductively coupled plasma (ICP) spectrometry. The iron content can be determined by quantitatively analyzing the solution of the soft magnetic powder using an ICP spectrometer after acid-desolving the soft magnetic powder. When carbon and/or nitrogen are contained in the soft magnetic powder, one may include the carbon and/or nitrogen contents obtained by carbon and/or nitrogen analysis as an impurity content. Then, the iron content of the soft magnetic powder can be calculated by subtracting the carbon and/or nitrogen contents as impurities from the value obtained by ICP spectrometry.

When the soft magnetic powder is not in a powder form, but is incorporated into a magnetic material (such as a powder magnetic core), analysis by ICP spectrometry is difficult to perform. In this case, the iron content can be quantified by EPMA measurement of the powder to be analyzed on a cross section of the magnetic material.

Examples of inevitable impurities contained in the soft magnetic powder in the insulated covered soft magnetic powder according to the present invention include Ni, Cr, Co, Mn, S, Zn, Zr, V, Mo, Si, Cu and Nb. Less than 1000 ppm, preferably less than 800 ppm, and further preferably less than 500 ppm of these inevitable impurities may be contained.

When a high-purity iron powder is produced by a conventional method, impurities including oxygen, carbon or nitrogen are taken into a soft magnetic powder, or after the soft magnetic powder is produced and before insulating material covering is formed, the iron purity of the soft magnetic powder lowers due to the oxidation of the iron powder, and the diffusion of oxygen into the inside of the iron powder, which is problematic. In particular, an iron powder having a small particle diameter has a large specific surface area, and thus, is easily affected by oxidation. Therefore, the iron purity of a conventional soft magnetic powder tends to lower. Lowered iron purity of the soft magnetic powder causes the magnetic properties of the insulated covered soft magnetic powder thus obtained to decline, and moreover, the magnetic properties of the powder magnetic core to decline. In contrast, the insulated covered soft magnetic powder according to the present invention is produced by the undermentioned method, whereby the soft magnetic powder can be produced, and a covering layer by an insulating material of an insulating covering oxide can be formed at the same time. Thus, the decline in iron purity due to impurities in the soft magnetic powder and the oxidation of the soft magnetic powder can be suppressed.

In the insulated covered soft magnetic powder according to the present invention, at least part of the surface of the soft magnetic powder is covered with an insulating covering oxide. The insulating covering oxide preferably contains a glass from the viewpoint such that the soft magnetic powder can be more uniformly covered. When the insulating covering oxide contains a glass, the entire insulating covering oxide may be amorphous, or the insulating covering oxide may contain a crystalline substance. The insulating covering oxide may be a crystalline oxide.

Generally, a metal oxide layer of iron oxide or the like is often formed on the surface of a high-purity iron powder that easily oxidizes. Covering a soft magnetic powder with an insulating covering oxide, compared to such a metal oxide layer, can lead to improved surface stability of the soft magnetic powder. The improved surface stability can suppress the oxidation of the soft magnetic powder over time. Moreover, covering a soft magnetic powder with an insulating covering oxide can lead to improved insulating properties of the soft magnetic powder. The improved insulating properties of the soft magnetic powder cause an insulating layer to be formed between particles of the soft magnetic powder in contact with each other when the powder is applied to a magnetic part. Therefore, the loss caused by the currents flowing among the particles of the soft magnetic powder (interparticle eddy currents) can be suppressed, and the core loss of the powder magnetic core can be reduced.

In the insulated covered soft magnetic powder according to the present invention, it is sufficient that at least part of the surface of the soft magnetic powder is covered with the insulating covering oxide, whereas a higher coverage of the insulating covering oxide to the soft magnetic powder is more preferable for preventing the soft magnetic powder from oxidizing.

Furthermore, the insulating covering oxide preferably contains Si. Containing Si in the insulating covering oxide can improve the aforementioned surface stability of the soft magnetic powder, and can improve the insulating properties of the insulated covered soft magnetic powder.

Preferably, the insulating covering oxide further contains an alkaline earth metal. Specifically, the insulating covering oxide preferably contains at least one of Ca and Ba. Containing Ca or Ba in the insulating covering oxide can improve the aforementioned surface stability of the soft magnetic powder, and can improve the insulating properties of the insulated covered soft magnetic powder.

The insulating covering oxide may further contain Fe as an inevitable component. Containing Fe in the insulating covering oxide leads to better wettability of the surface of the soft magnetic powder and the insulating covering oxide, which makes it easy to more uniformly cover the surface of the soft magnetic powder.

When being a glass, the insulating covering oxide is preferably an alkaline earth silicate.

The insulated covered soft magnetic powder according to the present invention has a 50% volume cumulative particle diameter (D₅₀) by laser diffraction/scattering particle size distribution measurement of 0.01 μm to 2.0 μm.

The insulated covered soft magnetic powder according to the present invention can also contribute to densification of a powder magnetic core. The insulated covered soft magnetic powder according to the present invention may be used alone, or may be used in combination with any soft magnetic powder having another particle diameter for densifying a powder magnetic core. Furthermore, the insulated covered soft magnetic powder according to the present invention having a D₅₀ within this range can suppress the eddy current loss made in the powder. In particular, the insulated covered soft magnetic powder according to the present invention having an average particle diameter (D₅₀) within this range can suppress the eddy current loss in the powder, which leads to a limited core loss because eddy current losses are dominant in core losses in a high frequency range.

When the insulated covered soft magnetic powder according to the present invention has an average particle diameter (D₅₀) of less than 0.01 μm, the amount of an additive that is added when the insulated covered soft magnetic powder is formed to be a powder magnetic core increases. Thus, the average particle diameter (D₅₀) is preferably 0.01 μm or more.

Furthermore, preferably, the insulated covered soft magnetic powder according to the present invention has a 90% volume cumulative particle diameter (D₉₀) by laser diffraction/scattering particle size distribution measurement of 0.1 μm to 3.5 μm. When the insulated covered soft magnetic powder having a D₉₀ of 0.1 μm to 3.5 μm is used, efficient filling of voids created by a soft magnetic powder having a larger particle diameter can take place when insulated covered soft magnetic powder in combination with the soft magnetic powder having a larger particle diameter are formed to be a powder magnetic core together, thereby the magnetic properties of the obtained powder magnetic core can be improved. The insulated covered soft magnetic powder according to the present invention having a D₉₀ within this range can also suppress the eddy current loss in the powder.

In particular, it is difficult to obtain by conventional methods an insulated covered soft magnetic powder using a high-purity iron powder having not only a small D₅₀ but also a small D₉₀ as a soft magnetic powder. However, an insulated covered soft magnetic powder using a high-purity iron powder having a D₅₀ of 0.1 μm or more and a D₉₀ of 3.5 μm or less as a soft magnetic powder can be obtained by using the undermentioned production method.

Preferably, the insulated covered soft magnetic powder according to the present invention is spherical. The insulated covered soft magnetic powder being spherical can lead to improved filling properties of the powder magnetic core.

The entire insulated covered soft magnetic powder according to the present invention has an oxygen content of 0.1 wt. % to 2.0 wt. %. The entire insulated covered soft magnetic powder having an oxygen content of 0.1 wt. % to 2.0 wt. %, in spite of the formation of the insulation covering of the insulating covering oxide on the surface of the soft magnetic powder, means that a small amount of the insulating covering oxide can form the insulation covering on the surface of the soft magnetic powder. That is, this means that the increase in particle diameter of the insulated covered soft magnetic powder due to the insulating covering oxide over the magnetic powder is suppressed. In addition, compared to a conventional soft magnetic powder, the oxidation of the soft magnetic powder itself and the diffusion of oxygen into the soft magnetic powder are considered to be suppressed.

Furthermore, the entire insulated covered soft magnetic powder according to the present invention has a carbon content of 0 wt. % to 0.2 wt. %. The entire insulated covered soft magnetic powder having a carbon content of 0 wt. % to 0.2 wt. % can lead to limited formation of a nonmagnetic solid solution formed of carbon and iron, which can suppress the decline in magnetic properties of the insulated covered soft magnetic powder.

Furthermore, the entire insulated covered soft magnetic powder according to the present invention has a nitrogen content of 0 wt. % to 0.2 wt. %. The entire insulated covered soft magnetic powder having a nitrogen content of 0 wt. % to 0.2 wt. % can lead to limited formation of a nonmagnetic solid solution formed of nitrogen and iron, which can suppress the decline in magnetic properties of the insulated covered soft magnetic powder.

Therefore, the entire insulated covered soft magnetic powder according to the present invention has an oxygen content of 0.1 wt. % to 2.0 wt. %, a carbon content of 0 wt. % to 0.2 wt. %, and a nitrogen content of 0 wt. % to 0.2 wt. %. When an insulated covered soft magnetic powder is produced by a conventional method, oxygen, carbon or nitrogen is taken into a soft magnetic powder at the stage of producing a high-purity iron powder that is a soft magnetic powder, or after the soft magnetic powder is produced and before an insulating material covering is formed, the iron purity of the soft magnetic powder lowers due to the oxidation of the iron powder, and the diffusion of oxygen into the inside of the iron powder, which is problematic. In particular, an iron powder having a small particle diameter has a large specific surface area, and thus, is easily affected by oxidation. Therefore, the iron purity of a conventional soft magnetic powder tends to lower. Lowered iron purity of the soft magnetic powder causes the magnetic properties of the insulated covered soft magnetic powder thus obtained to decline, and moreover, the magnetic properties of the powder magnetic core to decline. In contrast, the insulated covered soft magnetic powder produced by the according to the present invention is undermentioned method, whereby the soft magnetic powder can be produced, and a covering layer by an insulating material of an insulating covering oxide can be formed at the same time. Thus, the oxygen content, the carbon content, and the nitrogen content of the finally obtained insulated covered soft magnetic powder can be limited to 0.1 wt. % to 2.0 wt. %, 0 wt. % to 0.2 wt. %, and 0 wt. % to 0.2 wt. %, respectively.

The entire insulated covered soft magnetic powder according to the present invention has a total content of oxygen, carbon and nitrogen of 0.1 wt. % to 2.0 wt. %. The insulated covered soft magnetic powder according to the present invention is produced by the undermentioned method, whereby the soft magnetic powder can be produced, and a covering layer by an insulating material of an insulating covering oxide can be formed at the same time. Thus, the total content of oxygen, carbon and nitrogen of the insulated covered soft magnetic powder according to the present invention can be limited to 0.1 wt. % to 2.0 wt. % of the entire insulated covered soft magnetic powder. A limited total content of oxygen, carbon and nitrogen of the insulated covered soft magnetic powder of 0.1 wt. % to 2.0 wt. % of the entire insulated covered soft magnetic powder allows insulating properties to be given by the insulating covering oxide while high-purity iron of the soft magnetic powder itself is kept, and thus, limits the decline in magnetic properties of the insulated covered soft magnetic powder, which leads to improved magnetic properties of the powder magnetic core.

The surface of the insulated covered soft magnetic powder according to the present invention may be further covered with an insulating material according to application. An insulating material as used herein is not particularly limited, but examples thereof include inorganic oxides and organic substances. A covering method as used herein is not particularly limited, either. The covering can be performed by employing a generally used method.

Furthermore, preferably, a compact obtained by molding the insulated covered soft magnetic powder according to the present invention at a pressure of 64 MPa has a volume resistivity of 1.0×10⁵ Ωcm or more. While the insulated covered soft magnetic powder according to the present invention has a low oxygen content as described above, the insulation covering having high insulating properties is formed on the surface of the soft magnetic powder, and consequently the volume resistivity of the insulated covered soft magnetic powder, which is an index of insulating properties, becomes high. A compact obtained by molding the insulated covered soft magnetic powder at a pressure of 64 MPa having a volume resistivity of 1.0×10⁵ Ωcm or more can lead to an improved voltage capability of an inductor component when the insulated covered soft magnetic powder is formed to be the inductor component. The volume resistivity of a compact obtained by molding the insulated covered soft magnetic powder at a pressure of 64 MPa is not limited in particular as long as being 1.0×10⁵ Ωcm or more. The compact is considered to have sufficient insulating properties if the volume resistivity is 1.0×10¹⁴ Ωcm or less. The volume resistivity of a compact obtained by molding the insulated covered soft magnetic powder at a pressure of 64 MPa can be measured using a powder resistivity meter, such as a powder resistivity meter (resistivity meter Loresta GX MCP-T700 manufactured by Mitsubishi Chemical Analytech Co., Ltd.). The powder resistivity (volume resistivity) can be measured using a powder resistivity meter at a load of 64 MPa by adjusting the amount of the soft magnetic powder so that the thickness of the compact formed by the powder is 3 to 5 mm.

For a method of producing the insulated covered soft magnetic powder according to the embodiments of the present invention, it is desirable to prepared as a starting material powder (hereinafter referred to as “raw material powder”) a powder formed by uniformly mixing a raw material containing an iron component and a raw material containing an insulating covering oxide forming component. As the raw material containing an iron component, a salt such as a nitrate, a sulfate, a chloride, an ammonium salt, a phosphate, a carboxylate, a metal alcoholate, and a resinate is used. The insulating covering oxide forming component includes elements to form the insulating covering oxide with which the soft magnetic powder is to be covered. As the raw material containing an insulating covering oxide forming component, silicic acid, boric acid, phosphoric acid, any of silicates, borates and phosphates, or any metal salt such as nitrates, sulfates, chlorides, ammonium salts, phosphates, carboxylates, metal alcoholates, and resonates of metals is used.

The method of preparing the raw material powder is not particularly limited. For example, the preparation can be performed using the spray roasting process, the fluidized roasting process, the spray pyrolysis process, the hydrothermal process, the coprecipitation process, the solid phase process, or the like. The raw material powder may be obtained by crushing and mixing the raw material containing an iron component and the raw material containing an insulating covering oxide forming component.

For the raw material powder, preferably, the raw material containing an iron component and the raw material containing an insulating covering oxide forming component are mixed so that the insulating covering oxide formation component is 0.1 to 5.0 wt. % of the iron component in terms of an oxide. In other words, preferably, the raw material containing an iron component and the raw material containing an insulating covering oxide forming component are mixed so that the amount of “an oxide, assuming that the insulating covering oxide forming component in the raw material containing an insulating covering oxide forming component exist as the oxide,” is 0.1 to 5.0 wt. % of the amount of “iron in the raw material containing an iron component”. Mixing in this proportion can lead to the formation of the insulation coating by the insulating covering oxide on the surface of the soft magnetic powder.

Preferably, the raw material powder is prepared so as to have a volume-average particle diameter of 1.0 μm or less, preferably 0.9 μm or less, and further preferably 0.8 μm or less. Conventionally, it is difficult to fully mix a raw material containing an iron component and a raw material containing an insulating covering oxide forming component so as to lead to the aforementioned proportion in a powder form. However, mixing a raw material powder having a volume-average particle diameter of 1.0 μm or less can lead to a fully uniformly mixed raw material powder.

The insulated covered soft magnetic powder can be obtained by supplying the prepared raw material powder, and a reducing agent and a carrier gas together into a reaction vessel via a nozzle, and heating them at a temperature higher than the melting points of iron and the insulating covering oxide forming component in a dispersing state in a gas phase. When the insulating covering oxide is a complex oxide or a glass that contains a plurality of oxides, the melting point of the insulating covering oxide forming component means the melting point of this complex oxide or glass.

In this case, an inert gas such as nitrogen and argon, a mixed gas thereof, or the like is used for the carrier gas. A reducing gas such as hydrogen, carbon monoxide, methane, and an ammonia gas may be used depending on the need to control the atmosphere in the reaction vessel. The nozzle is not particularly limited. Any shape of a nozzle may be used, such as a nozzle having a circular or a polygonal cross section, a slit-shaped nozzle, a nozzle narrowed at a tip thereof, and a nozzle narrowed to the middle and widened at an opening part thereof.

In this method, one particle of the insulated covered soft magnetic powder is considered to be obtained per one particle of the raw material powder, and in the reaction vessel the following reaction is surmised to occur.

The raw material powder, and the reducing agent and the carrier gas together are supplied into the reaction vessel via the nozzle, and they are heated at a temperature higher than the melting points of iron and the insulating covering oxide forming component in a dispersing state in a gas phase, whereby each of the raw material powders melts in the reaction vessel. The insulating covering oxide forming component is repelled from the molten raw material powder to create the state where the circumference of the melt of iron as a core is covered with the melt of the insulating covering oxide forming component. The melts having passed through the reaction vessel are cooled as they are, and then, the soft magnetic powder, and the insulated covered soft magnetic powder such that the surface of the soft magnetic powder is covered with the insulating covering oxide are obtained.

Since iron is cooled after formed to be a melt once, iron forms high-purity iron powder. In addition, since the melt of the insulating covering oxide forming component is cooled with the melt of iron covered, the surface of the iron powder is covered with the insulating covering oxide after cooling. As described, the production of the iron powder and the formation of the covering layer by the insulating covering oxide can take place at the same time by this method. Thus, the insulating covering layer by the insulating covering oxide can be formed while the oxidation of the iron powder itself is suppressed.

Therefore, an insulated covered soft magnetic powder having a soft magnetic powder of less impurities, and an insulation coating by an insulating covering oxide of high insulating properties can be obtained by this method. A high-purity iron powder having a small particle diameter without insulation covering is highly active, and thus, is accompanied with the risk of sintering or combustion when recovered. Using the present method leads to high safety because a highly active iron powder can be recovered in the state where the powder is insulated covered with the insulating covering oxide, which is also advantageous.

In relation to the insulated covered soft magnetic powder obtained by this method, not only the insulated covered soft magnetic powder according to the present invention but also an insulated covered soft magnetic powder having an adjusted amount of an insulation coating can be obtained by adjusting the amount of the insulating covering oxide forming component in relation to the iron component at the stage of preparing the raw material powder. Specifically, an insulated covered soft magnetic powder such that the insulating covering oxide is 0.1 to 20 wt. % of a soft magnetic powder can be obtained.

Even in this case, an insulated covered soft magnetic powder comprising a soft magnetic powder having an iron content of 99.0 wt. % or more, wherein at least part of the surface of this soft magnetic powder is covered with the insulating covering oxide, and wherein the insulated covered soft magnetic powder has a 50% volume cumulative particle diameter (D₅₀) by laser diffraction/scattering particle size distribution measurement of 0.01 μm to 2.0 μm, can be obtained.

In this case, the oxygen content of the entire insulated covered soft magnetic powder varies according to the amount of the insulating covering oxide, whereas the carbon content and the nitrogen content of the entire insulated covered soft magnetic powder can be held down to as low as 0 wt. % to 0.2 wt. %, and 0 wt. % to 0.2 wt. %, respectively.

Furthermore, in relation to the insulated covered soft magnetic powder obtained by this method, not only the insulated covered soft magnetic powder according to the present invention but also an insulated covered soft magnetic powder such that a soft magnetic powder is alloyed can be obtained by adding a raw material containing a component that forms an alloy with iron at the stage of preparing the raw material powder. Specifically, an insulated covered soft magnetic powder with at least part of the surface of a soft magnetic powder being covered with the insulating covering oxide can be obtained, wherein the soft magnetic powder is an iron-based alloys such that a component that forms an alloy with iron is 0.1 to 10 wt. % of the total components forming the soft magnetic powder. In relation to this insulated covered soft magnetic powder using an iron-based alloy as a soft magnetic powder, an insulated covered soft magnetic powder formed by adjusting the amount of the insulating covering oxide forming component can be also obtained by the foregoing method.

In this case, a soft magnetic powder that is an iron-based alloy having an iron content of 90.0 wt. % or more, and an insulated covered soft magnetic powder such that at least part of the surface of this soft magnetic powder is covered with the insulating covering oxide can be obtained. The insulated covered soft magnetic powder obtained can have a 50% volume particle diameter (D₅₀) by laser diffraction/scattering particle size distribution measurement of 0.01 μm to 2.0 μm, a carbon content and a nitrogen content of the entire insulated covered soft magnetic powder of 0 wt. % to 0.2 wt. %, and 0 wt. % to 0.2 wt. %, respectively, and a mass ratio of the insulating covering oxide to the soft magnetic powder of 0.1 to 20 wt. %.

In this case, the insulated covered soft magnetic powder obtained may have an oxygen content of 0.1 wt. % to 2.0 wt. % of the entire insulated covered soft magnetic powder, and a total content of oxygen, carbon and nitrogen of 0.1 wt. % to 2.0 wt. % of the entire insulated covered soft magnetic powder by adjusting the amount of the insulating covering oxide.

The insulated covered soft magnetic powders and methods of producing the insulated covered soft magnetic powders according to the embodiments of the present invention have the following configurations:

[1] An insulated covered soft magnetic powder wherein, the insulated covered soft magnetic powder comprises a soft magnetic powder having an iron content of 99.0 wt. % or more, at least part of the surface of the soft magnetic powder is covered with an insulating covering oxide,
the insulated covered soft magnetic powder has a 50% volume cumulative particle diameter (D₅₀) of 0.01 μm to 2.0 μm, as measured by laser diffraction/scattering particle size distribution measurement,
oxygen, carbon and nitrogen contents of an entirety of the insulated covered soft magnetic powder is
0.1 wt. % to 2.0 wt. % of oxygen,
0 wt. % to 0.2 wt. % of carbon,
and 0 wt. % to 0.2 wt. %, of nitrogen,
and further, a total content of oxygen, carbon and nitrogen of the entirety of the insulated covered soft magnetic powder is 0.1 wt. % to 2.0 wt. %.
   [2] An insulated covered soft magnetic powder according to an embodiment of the present invention is the insulated covered soft magnetic powder according to the section [1], wherein the insulating covering oxide contains a glass.
   [3] An insulated covered soft magnetic powder according to an embodiment of the present invention is the insulated covered soft magnetic powder according to the section [1], wherein the insulating covering oxide contains a crystalline oxide.
   [4] An insulated covered soft magnetic powder according to an embodiment of the present invention is the insulated covered soft magnetic powder according to any one of the sections [1] to [3], wherein a compact obtained by molding the insulated covered soft magnetic powder at a pressure of 64 MPa has a volume resistivity of 1.0×10⁵ Ωcm to 1.0×10¹⁴ Ωcm.
   [5] An insulated covered soft magnetic powder according to an embodiment of the present invention is the insulated covered soft magnetic powder according to any one of the sections [1] to [4], wherein the insulated covered soft magnetic powder has a 90% volume cumulative particle diameter (D₉₀) of 0.1 μm to 3.5 μm, as measured by laser diffraction/scattering particle size distribution measurement. [6] An insulated covered soft magnetic powder according to an embodiment of the present invention is the insulated covered soft magnetic powder according to any one of the sections [1] to [5], wherein the insulating covering oxide contains Si.
   [7] An insulated covered soft magnetic powder according to an embodiment of the present invention is the insulated covered soft magnetic powder according to any one of the sections [1] to [6], wherein the insulating covering oxide contains Ca or Ba.
   [8] An insulated covered soft magnetic powder according to an embodiment of the present invention is the insulated covered soft magnetic powder according to any one of the sections [1] to [7], wherein the insulating covering oxide contains Fe.
   [9] An insulated covered soft magnetic powder according to an embodiment of the present invention is the insulated covered soft magnetic powder according to any one of the sections [2] and [4] to [8], wherein the glass contained in the insulating covering oxide is an alkaline earth silicate.
   [10] A method of producing the insulated covered soft magnetic powder according to an embodiment of the present invention is
a method of producing the insulated covered soft magnetic powder according to the section [1], the method including:
preparing a raw material powder including a raw material containing an iron component, and a raw material containing an insulating covering oxide forming component;
and supplying the raw material powder, and a reducing agent and a carrier gas together into a reaction vessel via a nozzle, and heating them in a gas phase,
wherein a content of the insulating covering oxide formation component in the raw material powder is 0.1 wt. % to 5.0 wt. % of the iron component in terms of an oxide,
and the heating in the heating step is performed at a temperature higher than melting points of iron and the insulating covering oxide forming component.
   [11] A method of producing the insulated covered soft magnetic powder according to an embodiment of the present invention is the method of producing the insulated covered soft magnetic powder according to the section [10],
wherein the raw material powder has a volume-average particle diameter of 1.0 μm or less.
   [12] An insulated covered soft magnetic powder according to an embodiment of the present invention is an insulated covered soft magnetic powder such that
An insulated covered soft magnetic powder wherein, the insulated covered soft magnetic powder comprises a soft magnetic powder having an iron content of 99.0 wt. % or more, at least part of the surface of the soft magnetic powder is covered with an insulating covering oxide,
the insulated covered soft magnetic powder has a 50% volume cumulative particle diameter (Ds) of 0.01 μm to 2.0 μm, as measured by laser diffraction/scattering particle size distribution measurement,
carbon and nitrogen contents of an entirety of the insulated covered soft magnetic powder is
0 wt. % to 0.2 wt. %,
and 0 wt. % to 0.2 wt. %, respectively,
and a content of the insulating covering oxide is 0.1 wt. % to 20 wt. % of the soft magnetic powder.
   [13] An insulated covered soft magnetic powder according to an embodiment of the present invention is an insulated covered soft magnetic powder such that
at least part of a surface of a soft magnetic powder having an iron content of 90.0 wt. % or more is covered with an insulating covering oxide,
wherein a content of a component that forms an alloy with iron in the soft magnetic powder of 0.1 wt. % to 10 wt. % of an entire soft magnetic powder forming component,
the insulated covered soft magnetic powder has a 50% volume cumulative particle diameter (D₅₀) of 0.01 μm to 2.0 μm, as measured by laser diffraction/scattering particle size distribution measurement,
carbon and nitrogen contents of an entirety of the insulated covered soft magnetic powder is
0 wt. % to 0.2 wt. %,
and 0 wt. % to 0.2 wt. %, respectively,
and a content of the insulating covering oxide is 0.1 wt. % to 20 wt. % of the soft magnetic powder.
   [14] An insulated covered soft magnetic powder according to an embodiment of the present invention is the insulated covered soft magnetic powder according to the section [13], wherein
an oxygen content is 0.1 wt. % to 2.0 wt. % of the entirety of the insulated covered soft magnetic powder,
and further, a total content of oxygen, carbon and nitrogen of the entirety of the insulated covered soft magnetic powder is 0.1 wt. % to 2.0 wt. %.

### EQUIVALENTS

It can be understood that the structures and/or methods described in the present specification are shown as examples, and thus, numerous modifications thereof are possible. Therefore, specific disclosures or examples in the present specification should not be considered as limitations. The specific procedures or methods described in the present specification can each show one of a plurality of processing methods. Therefore, the explained and/or described various operations may be each performed in the explained and/or described order or may be omitted. Similarly, the orders of the above methods may be changed.

The subject of this disclosure encompasses all novel and non-obvious combinations and subcombinations of a variety of the methods, and systems and structures, which are disclosed in this description, and any other features, functions, operations, and/or properties; and all equivalents thereof.

### EXAMPLES

Hereinafter the present invention will be specifically described based on examples and comparative examples, but is not limited thereto.

### [Producing Insulated Covered Soft Magnetic Powder]

### Examples 1 to 10

A stock solution was prepared using iron nitrate nonahydrate, tetraethoxysilane (TEOS), barium nitrate, and calcium nitrate tetrahydrate.

Iron nitrate nonahydrate, tetraethoxysilane (TEOS), barium nitrate, and calcium nitrate tetrahydrate were dissolved in water so that the ratio SiO₂:BaO:Cao equals to 48:38:14, and the sum of SiO₂, BaO, and CaO was 1.5 wt. % of iron in iron nitrate nonahydrate assuming that tetraethoxysilane (TEOS), barium nitrate, and calcium nitrate tetrahydrate formed SiO₂, BaO, and CaO, respectively. The resultant was used as a stock solution.

The mixed oxide powder was obtained by subjecting this stock solution to spray drying. Furthermore, this mixed oxide powder was pulverized with a airflow pulverizer to prepare the resultant raw material powder having a volume-average particle diameter of approximately 0.8 μm. This raw material powder accompanied with a carrier gas at 200 L/min, and monoethylene glycol at 30 g/min as a reducing agent were each spray-fed to a reactor heated to 1600° ° C. to be subjected to heat treatment. The heat-treated powder was fully cooled, and thereafter caught in a bag filter as an insulated covered soft magnetic powder. These steps were carried out for 10 batches, and the resultants from the respective batches were identified as examples 1 to 10. The following analyses were performed on the resultant insulated covered soft magnetic powders.

### [ICP Measurement]

An insulated covered part of 1.0 g of the insulated covered soft magnetic powder of each of examples 1 to 10 was removed by heat treatment with a 25 wt. % NaOH aqueous solution at 90° C. for 5 hours, followed by hot water washing. The soft magnetic powder, from which the insulated covered part was removed, was heated to dissolve in hydrochloric acid, and was subjected to, after appropriate dilution, quantitative analysis using an ICP optical emission spectrometer (ICPS-7510 manufactured by Shimadzu Corporation) for each element. The iron content of the soft magnetic powder was calculated from the obtained data. The results are shown in table 1.

### [Measurement of Oxygen, Carbon, and Nitrogen Contents]

The oxygen content of the insulated covered soft magnetic powder of each of examples 1 to 10 was measured using an oxygen/nitrogen analyzer (EMGA manufactured by Horiba, Ltd.). 10 mg of the insulated covered soft magnetic powder was collected and put into a crucible for combustion, and the crucible for combustion was set in the oxygen/nitrogen analyzer for the measurement of oxygen and nitrogen contents. The oxygen contents and the nitrogen contents calculated from the obtained data are shown in table 1.

The carbon content of the insulated covered soft magnetic powder of each of examples 1 to 10 was measured using (EMIA manufactured by Horiba, Ltd.). 0.3 g of the insulated covered soft magnetic powder was collected and put into a crucible for combustion, and the crucible for combustion was set in the carbon analyzer for the measurement of carbon content. The carbon contents calculated from the obtained data are shown in table 1.

The carbon and nitrogen contents of the insulated covered soft magnetic powder measured for the examples were considered as an impurity content of the soft magnetic powder. Based on these values, the iron content of the insulated covered soft magnetic powder of each of the examples is shown in table 1.

### [Particle Size Distribution Measurement]

Particle size distribution of the insulated covered soft magnetic powder of each of examples 1 to 10 was measured using a laser particle size distribution measurement instrument (LA-960 manufactured by Horiba, Ltd.). The obtained values are each shown in table 1.

### [Volume Resistivity]

The volume resistivity of a compact of the insulated covered soft magnetic powder was measured using a powder resistivity meter (resistivity meter Loresta GX MCP-T700 manufactured by Mitsubishi Chemical Analytech Co., Ltd.). Into a probe unit of the powder resistivity meter, 5.0 g of the obtained soft magnetic powder was stuffed and pressurized at room temperature)(25° ° C., and the powder resistivity (volume resistivity) at the time point when a load of 64 MPa was applied to the compact of a columnar shape having a diameter of 20 mm was measured. The obtained values are each shown in table 1.

### Comparative Example 1

For a commercially available carbonyl iron powder, the iron content of the soft magnetic powder, the particle diameter, the oxygen content, the carbon content, the nitrogen content, and the powder resistivity (volume resistivity) were each measured in the same manner as for examples 1 to 10. Iron pentacarbonyl is used as a raw material of a carbonyl iron powder, and the processing temperature thereof when the iron powder is produced is not high. Thus, a carbonyl iron powder is a soft magnetic powder having high carbon and nitrogen contents.

### Comparative Example 2

To a slurry formed by dispersing 2.5 g of the commercially available carbonyl iron powder into 40 g of isopropyl alcohol, 0.37 g of TEOS was added at once. After the TEOS was added, the resultant was continuously stirred for 5 minutes to cause a hydrolysis product of TEOS and the carbonyl iron powder to react. Successively, 4.5 g of a 28 wt. % ammonia water was added at an addition rate of 0.1 g/min to the slurry, which had been kept for 5 minutes since the addition of TEOS. After the completion of the addition of the ammonia water, the resultant slurry was kept for 1 hour while stirring to form an insulating covering oxide covering layer on the surface of the carbonyl iron powder. Thereafter, the slurry was filtered out using a pressure filtration device, the resultant was vacuum dried at 120° ° C. for 3 hours, and thus the resultant insulated covered soft magnetic powder was obtained. The particle diameter, the oxygen content, the carbon content, the nitrogen content, and the powder resistivity (volume resistivity) of the obtained insulated covered soft magnetic powder were each measured in the same manner as for examples 1 to 10.

Iron pentacarbonyl is used as a raw material of a carbonyl iron powder, and the processing temperature thereof when the iron powder is produced is not high. Thus, a carbonyl iron powder is a soft magnetic powder having high carbon and nitrogen contents. Therefore, when the carbonyl iron powder was subjected to sol-gel coating, the insulating properties of the obtained insulated covered soft magnetic powder were high, whereas the carbon and nitrogen contents thereof were high. Moreover, the sol-gel coating further increased the oxygen content of the insulated covered soft magnetic powder.

### Comparative Example 3

A stock solution was prepared by adding and mixing iron nitrate, TEOS and barium nitrate, and calcium nitrate, and ethylene glycol as a reducing agent. The metal component concentration of the solution was set in 20 g/L, and the amount of the reducing agent was set in 20 wt. % of the entire solution. The form of this stock solution was changed to fine droplets using an ultrasonic atomizer, and the droplets were supplied together with a nitrogen gas as a carrier gas into a ceramic tube heated with an electric furnace to 1550° C. The droplets passed through a heating zone to be subjected to heat treatment, and was caught in a bag filter after fully cooled. The particle diameter, the oxygen content, the carbon content, the nitrogen content, and the powder resistivity (volume resistivity) of the obtained insulated covered soft magnetic powder were each measured in the same manner as for examples 1 to 10. The iron content of the soft magnetic powder was calculated from the value obtained by subtracting the elements forming the insulating covering oxide covering layer and the amounts thereof from the value measured by ICP optical emission spectrometry, and the values obtained by the measurement of the carbon and nitrogen contents in the same manner as for examples 1 to 10.

the insulated covered soft magnetic powder obtained by the spray pyrolysis process was found to have high insulating properties, whereas the insulated covered soft magnetic powder thus obtained was found to have a high oxygen content since the solution was used as the raw material.

TABLE 1

| | | Insulation | | | | | | |
|---|---|---|---|---|---|---|---|---|
| | Soft | covering | | | | | | |
| | magnetic | Insulating | Insulated covered soft magnetic powder | | | | | |
| | powder | covering | Volume cumulative | | | | | Volume |
| | Iron | oxide | particle size distribution | | Content | | | resistivity |
| | content/ | forming | D₅₀/ | D₉₀/ | Oxygen/ | Carbon/ | Nitrogen/ | (64 MPa)/ |
| | wt. % | elements | μm | μm | wt. % | wt. % | wt. % | Ω · cm |
| Example 1 | 99.3 | Si, Ba, Ca | 0.82 | 1.31 | 1.28 | 0.03 | 0.03 | ≥1.0 × 10⁸ |
| Example 2 | 99.3 | Si, Ba, Ca | 1.19 | 2.45 | 1.11 | 0.03 | 0.03 | 1.0 × 10⁸ |
| Example 3 | 99.3 | Si, Ba, Ca | 0.91 | 1.55 | 1.65 | 0.04 | 0.03 | 2.3 × 10⁸ |
| Example 4 | 99.3 | Si, Ba, Ca | 0.81 | 1.43 | 1.42 | 0.04 | 0.03 | 9.2 × 10⁶ |
| Example 5 | 99.3 | Si, Ba, Ca | 0.77 | 1.32 | 1.27 | 0.04 | 0.03 | 1.8 × 10⁷ |
| Example 6 | 99.3 | Si, Ba, Ca | 0.72 | 1.30 | 1.42 | 0.05 | 0.03 | 1.1 × 10⁸ |
| Example 7 | 99.3 | Si, Ba, Ca | 0.67 | 1.19 | 1.41 | 0.05 | 0.03 | 4.2 × 10⁸ |
| Example 8 | 99.2 | Si, Ba, Ca | 0.68 | 1.13 | 1.49 | 0.10 | 0.03 | ≥1.0 × 10⁸ |
| Example 9 | 99.2 | Si, Ba, Ca | 0.75 | 1.29 | 1.23 | 0.09 | 0.03 | ≥1.0 × 10⁸ |
| Example 10 | 99.2 | Si, Ba, Ca | 0.63 | 1.02 | 1.50 | 0.08 | 0.03 | ≥1.0 × 10⁵ |
| Comparative | 97.5 | — | 1.37 | 2.31 | 0.79 | 0.95 | 0.65 | 2.4 × 10⁻¹ |
| example 1 | | | | | | | | |
| Comparative | 97.5 | Si | 1.41 | 2.47 | 1.89 | 1.02 | 0.66 | 5.3 × 10⁵ |
| example 2 | | | | | | | | |
| Comparative | 98.3 | Si, Ba, Ca | 0.71 | 1.11 | 3.20 | 0.05 | 0.03 | 4.0 × 10⁸ |
| example 3 | | | | | | | | |

1. An insulated covered soft magnetic powder wherein, the insulated covered soft magnetic powder comprises a soft magnetic powder having an iron content of 99.0 wt. % or more, at least part of the surface of the soft magnetic powder is covered with an insulating covering oxide,
the insulated covered soft magnetic powder has a 50% volume cumulative particle diameter (D₅₀) of 0.01 μm to 2.0 μm, as measured by laser diffraction/scattering particle size distribution measurement,
oxygen, carbon and nitrogen contents of an entirety of the insulated covered soft magnetic powder is
0.1 wt. % to 2.0 wt. % of oxygen,
0 wt. % to 0.2 wt. % of carbon,
and 0 wt. % to 0.2 wt. % of nitrogen,
and further, a total content of oxygen, carbon and nitrogen of the entirety of the insulated covered soft magnetic powder is 0.1 wt. % to 2.0 wt. %.

2. The insulated covered soft magnetic powder according to claim 1, wherein the insulating covering oxide contains a glass.

3. The insulated covered soft magnetic powder according to claim 1, wherein the insulating covering oxide contains a crystalline oxide.

4. The insulated covered soft magnetic powder according to claim 1, wherein a compact obtained by subjecting molding the insulated covered soft magnetic powder at a pressure of 64 MPa has a volume resistivity of 1.0×10⁵ Ωcm to 1.0×10¹⁴ Ωcm.

5. The insulated covered soft magnetic powder according to claim 1, wherein the insulated covered soft magnetic powder has a 90% volume cumulative particle diameter (D₉₀) of 0.1 μm to 3.5 μm, as measured by laser diffraction/scattering particle size distribution measurement.

6. The insulated covered soft magnetic powder according to claim 1, wherein the insulating covering oxide contains Si.

7. The insulated covered soft magnetic powder according to claim 1, wherein the insulating covering oxide contains Ca or Ba.

8. The insulated covered soft magnetic powder according to claim 1, wherein the insulating covering oxide contains Fe.

9. The insulated covered soft magnetic powder according to claim 2, wherein the glass contained in the insulating covering oxide is an alkaline earth silicate.

10. The insulated covered soft magnetic powder according to claim 2, wherein a compact obtained by subjecting molding the insulated covered soft magnetic powder at a pressure of 64 MPa has a volume resistivity of 1.0×10⁵ Ω2 cm to 1.0×10¹⁴ Ωcm.

11. The insulated covered soft magnetic powder according to claim 2, wherein the insulated covered soft magnetic powder has a 90% volume cumulative particle diameter (D₉₀) of 0.1 μm to 3.5 μm, as measured by laser diffraction/scattering particle size distribution measurement.

12. The insulated covered soft magnetic powder according to claim 2, wherein the insulating covering oxide contains Si.

13. The insulated covered soft magnetic powder according to claim 2, wherein the insulating covering oxide contains Ca or Ba.

14. The insulated covered soft magnetic powder according to claim 2, wherein the insulating covering oxide contains Fe.

15. The insulated covered soft magnetic powder according to claim 5, wherein the insulating covering oxide contains Si.

16. The insulated covered soft magnetic powder according to claim 5, wherein the insulating covering oxide contains Fe.

17. The insulated covered soft magnetic powder according to claim 11, wherein the insulating covering oxide contains Si.

18. The insulated covered soft magnetic powder according to claim 11, wherein the insulating covering oxide contains Fe.

19. The insulated covered soft magnetic powder according to claim 11, wherein the glass contained in the insulating covering oxide is an alkaline earth silicate.
